(19) United States
(12) Patent Application Publication
(10) Pub. No.: US 2010/0198890 A1
(43) Pub. Date: Aug. 5, 2010

(54) METHOD AND APPARATUS FOR MULTIMEDIA DATA MANAGEMENT ON MOBILE DEVICES

(76) Inventor: Thalapathy Krishnamurthy, Bangalore Karnataka (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/668,815

(22) PCT Filed: Aug. 28, 2007
(86) PCT No.: PCT/IN07/00368

§ 371 Date: Jan. 12, 2010

(51) Int. Cl. G06F 17/30

(52) U.S. Cl. 707/827; 707/E17.01; 707/829

(57) ABSTRACT

A method and apparatus for managing multimedia files of a mobile device is disclosed. In one embodiment, a method of managing captured images of a mobile device having an optical image sensor includes storing metadata associated with each of the captured images in an over-the-air server. The stored metadata is then allowed for previewing and retrieving desired captured images via a Common User Repository (CUR).

### FIELD OF THE INVENTION

The present invention relates generally to mobile data storage and more particularly relates to techniques for performing multimedia mobile data storage.

### BACKGROUND

Recently, due to the rapid progress in telecommunications, development of mobile communication devices having various functions has been required in addition to mobile communication devices which transfer only voices. Therefore, recent mobile communication devices have multimedia capabilities by which image and video data communications are performed in addition to a function of voice communication. Especially, the mobile communication terminals employing digital camera modules, as well as camera phones having digital camera functions, are widely supplied and used.

A mobile communication device which employs a digital camera module comprises a function by which a scene or a moving image or the like can be photographed and stored. Further, the mobile communication device comprises an image data transmitting and receiving functions, and can transmit the image data of a photographed picture to another remote device or retrieve an already stored image data of a photographed picture from an another remote mobile communication device or a over-the-air server via a base station.

Generally, when managing the pictures stored in the mobile device, the device displays the stored pictures on a liquid crystal display (LCD) section sequentially one by one. Recently, due to advances in digital camera functions mobile operators are offering large multimedia storage in the mobile devices as well as memory residing in the mobile networks where mobile subscribers can store, retrieve and manage the multimedia files, such as audio files, photo files, and video files of the mobile communication devices. However, this can require considerable amount of real-time uploading and downloading of entire voice, image, and video data files over the air. This can result in requiring significant amount of air time minutes, can be very expensive and can inhibit the realization of such services.

### BRIEF DESCRIPTION OF THE DRAWINGS

Example embodiments are illustrated by way of example and not limitation in the figures of the accompanying drawings, in which like references indicate similar elements and in which:

FIG. 1 is a process flow illustrating using Common Usage Repository (CUR) for sourcing multimedia data storage on mobile devices, according to one embodiment.

FIG. 2 is a block diagram illustrating a mobile multimedia data management system, according to one embodiment.

FIG. 3 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

A method and apparatus for managing multimedia files on mobile devices using metadata associated with the voice, image and video data files. In the following description, for purposes of explanation, numerous specific details are set forth in order to provide a thorough understanding of the various embodiments. It will be evident, however, to one skilled in the art that the various embodiments may be practiced without these specific details.

The term Common User Repository (CUR) refers to a virtual pointer to various data sources associated with a subscriber in a mobile network, such as HLR (Home Location Register) server, HS (Home Subscriber) Server, Location server, presence server, Buddy list server, Billing/customer relationship management (CRM) server and the like. The CUR is a centralized source for providing a single subscriber data view, which does not require storing all the associated data. Further, the CUR provides a centralized source by maintaining pointers to the various multimedia files.

The terms “images” and “photos” are used interchangeably throughout the document.

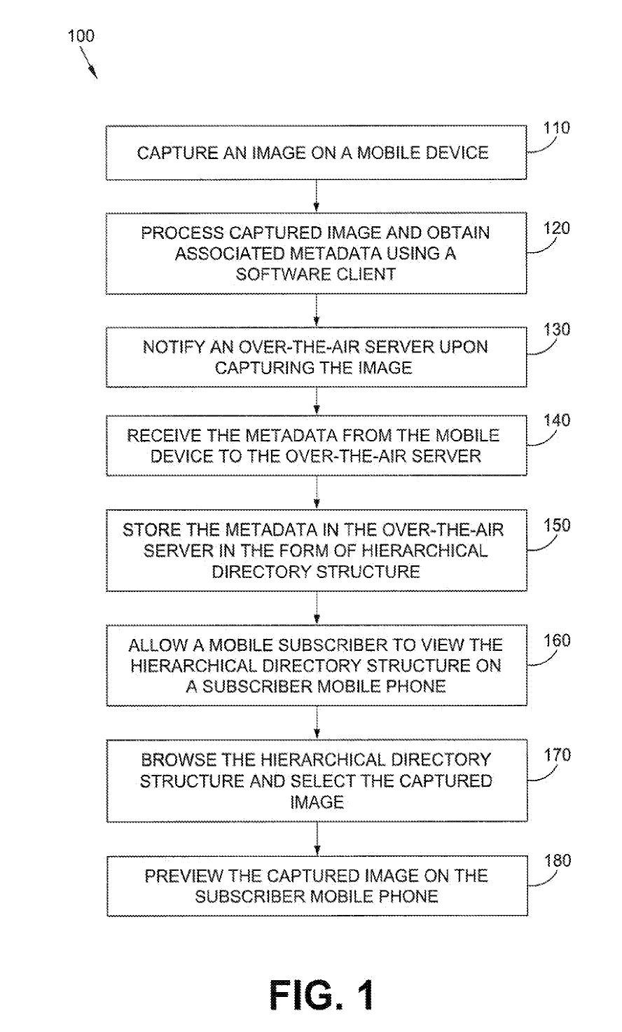

FIG. 1 is a process flow 100 illustrating a method of managing multimedia files in a mobile device using metadata associated with the voice, image and video data files, according to one embodiment. In operation 110, an image of machine-readable coded data is captured on a mobile device having an optical sensor. In some embodiments, the mobile device is a mobile phone having an optical sensor. In operation 120, the captured image is processed on the mobile phone to obtain metadata associated with the captured image using a software client residing in the mobile phone. In some embodiments, the metadata defines the general attributes associated with the captured image. Exemplary general attributes includes names of photo files, location of the photo files in the directory hierarchy, place where the photo was taken, date when the photo was taken and the like. In these embodiments, the metadata facilitates in maintaining pointers to the captured images in associated mobile devices.

In operation 130, the software client notifies an over-the-air server of the captured image based on sensing a change in a mobile device image directory in the mobile device. In some embodiments, the software client notifies the over-the air server via HTTP connection. In other embodiments, a CUR queries via HTTP the mobile device directory upon a request from a client application or a mobile subscriber to browse the captured images stored in the mobile device directory.

In operation 140, the metadata associated with the captured picture is then received by the over-the-air server upon receiving the notification. In operation 150, the received metadata is then stored in the over-the-air server. In some embodiments, the metadata associated with the captured image is stored in the form of a hierarchical directory structure in the over-the-air server. In these embodiments, the hierarchical directory structure includes multimedia files, such as data files, voice files, captured image files, video files and the like. In some embodiments, the metadata associated with the multimedia files are stored in the form of a hierarchical directory structure in the over-the-air server.

In operation 160, a mobile subscriber is allowed to view the hierarchical directory structure on a subscriber mobile phone using a plug-in module residing in the CUR. In operation 170, the mobile subscriber browses the hierarchical directory structure and selects the captured image using the mobile device. In operation 180, the selected image is previewed by the mobile subscriber. In some embodiments, the selected image is previewed using formats, such as compressed format, low resolution format, thumbnail format and so on.

In some embodiments, a mobile subscriber is allowed to view the hierarchical directory structure is allowed to view on a mobile device using the software client associated with the CUR and residing in the mobile subscriber device. In other embodiments, a mobile subscriber is allowed to view the hierarchical directory structure on a mobile device using a client device connected to the CUR via a mobile network, wireless LAN network, and the like. In some embodiments, the mobile subscriber allows access to desired group of mobile subscribers and CUR users to view the hierarchical directory structure residing in the over-the-air servers to preview the captured image. In some embodiments, the previewed captured image is retrieved by the mobile subscribers and CUR users. In these embodiments, a mobile subscriber browses the hierarchical directory structure and selects one of the multimedia files using the subscriber mobile device. The selected one of the multimedia files is then previewed by the mobile subscriber on the mobile device.

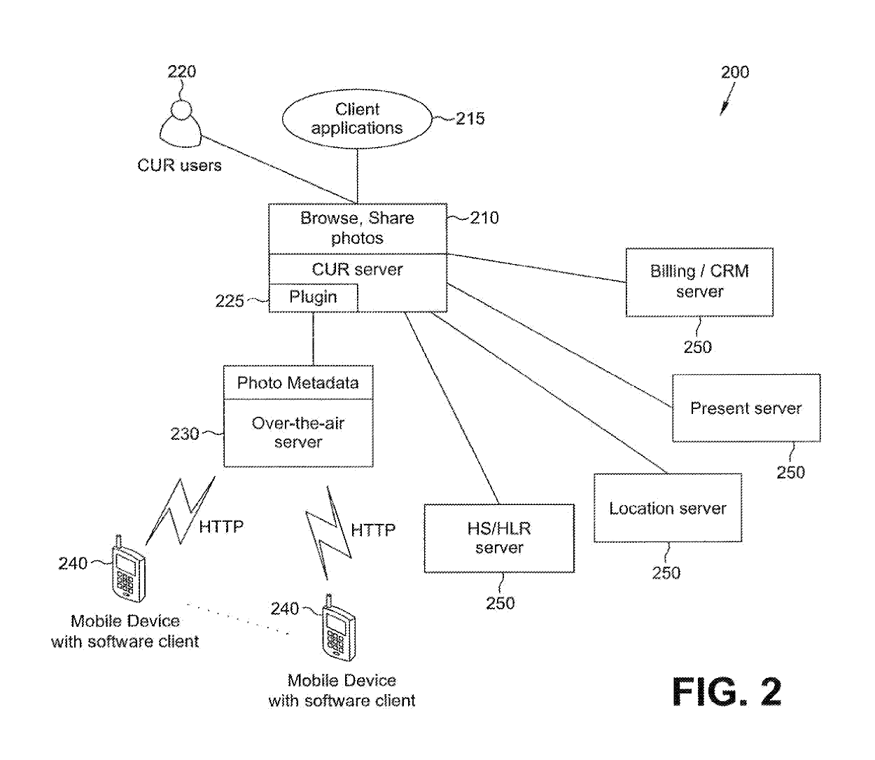

FIG. 2 is a block diagram illustrating a mobile multimedia data management system 200 for managing captured images of a mobile device, according to one embodiment. Particularly, FIG. 2 illustrates using a CUR server 210 as a virtual pointer to one or more mobile devices 240 to retrieve metadata associated with the captured images from the one or more mobile devices 240 and to provide the ability to share the metadata with other mobile users connected to an over-the-air server 230. The over-the-air server 230 may serve as an intermediate backup holding the metadata to which the CUR server 210 via an associated plug-in 225 may have the virtual pointer to the one or more mobile devices 240. Also as shown in FIG. 2, the mobile multimedia data management system 200 includes client applications 215 and CUR users 220 communicatively connected to the CUR server 225. Further as shown in FIG. 2, the multimedia data management system 200 includes other servers, such as HSS/HLR server, Location Server, Presence Server, Billing/CRM server and so on to the CUR server. Furthermore as shown in FIG. 2, the CUR server 210 provides a virtual pointer to various mobile subscriber data servers, such as HS/HLR server, Location server, Present server, Billing/CRM server and so on.

In operation, a mobile device including an optical image sensor 240 captures a picture. A software client residing in the mobile device 240 then processes the captured image to obtain metadata associated with the captured image. In these embodiments, the metadata includes general attributes associated with the captured image. The software client residing in the mobile device 240 then notifies the over-the-air server 230 of the capture image based on sensing a change in an image directory in the mobile device 240. In some embodiments, the notification to the over-the-air server 230 comes from the CUR user 220 or the client application 215 query.

The over-the-air server 230 then stores the metadata associated with the captured image in a hierarchical directory structure upon receiving the notification from the mobile device 240. In some embodiments, the metadata associated with the captured image can come along with the notification to the over-the air server 230. In these embodiments, the over-the-air server 230 stores the metadata received with the notification. In some embodiments, the hierarchical directory structure includes file names associated with the captured images.

The CUR server 210 allows a mobile subscriber to view the hierarchical directory structure on the mobile device using the software client residing in the mobile device 240. The CUR user 220 can be a mobile subscriber. The mobile subscriber browses the hierarchical directory structure residing in the over-the-air server 230 and selects one of the captured images using the mobile device 240. The mobile subscriber then previews the selected one of the captured images on the mobile device 240. The mobile subscriber previews the selected one of the captured images on the mobile device in formats, such as compressed format, low resolution format, thumbnail format and so on.

In some embodiments, the mobile subscriber allows access to other selected one or more mobile subscribers and CUR users to view hierarchical directory structure residing in the over-the-air server 230 and chose a desired one of the captured images from the hierarchical directory structure using the software client via the CUR server 210. The selected one or more subscribers then retrieve the desired one of the captured images using the software client via the CUR server 210. The operation of the mobile multimedia data management system 200 is explained in more detail with reference to FIG. 1.

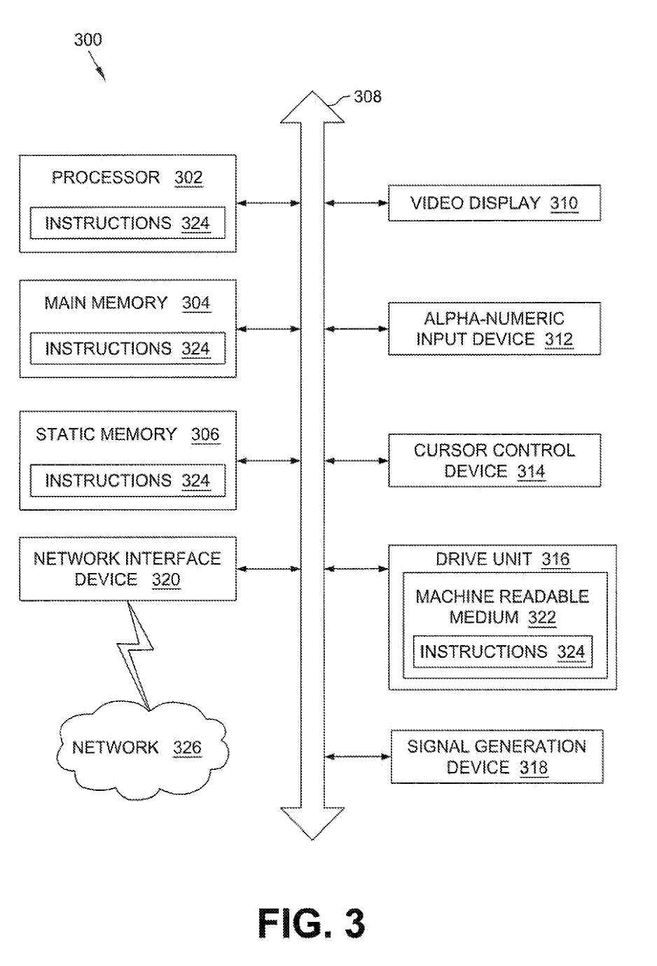

FIG. 3 is a diagrammatic system view 300 of a data processing system in which any of the embodiments disclosed herein may be performed, according to one embodiment. Particularly, the diagrammatic system view of FIG. 3 illustrates a processor 302, a main memory 304, a static memory 306, a bus 308, a video display 310, an alpha-numeric input device 312, a cursor control device 314, a drive unit 316, a signal generation device 318, a network interface device 320, a machine readable medium 322, instructions 324 and a network 326.

The diagrammatic system view 300 may indicate a personal computer and/or a data processing system in which one or more operations disclosed herein are performed. The processor 302 may be a microprocessor, a state machine, an application specific integrated circuit, a field programmable gate array, etc. (e.g., Intel® Pentium® processor). The main memory 304 may be a dynamic random access memory and/or a primary memory of a computer system. The static memory 306 may be a hard drive, a flash drive, and/or other memory information associated with the data processing system.

The bus 308 may be an interconnection between various circuits and/or structures of the data processing system. The video display 310 may provide graphical representation of information on the data processing system. The alpha-numeric input device 312 may be a keypad, keyboard and/or any other input device of text (e.g., a special device to aid the physically handicapped). The cursor control device 314 may be a pointing device such as a mouse. The drive unit 316 may be a hard drive, a storage system, and/or other longer term storage subsystem.

The signal generation device 318 may be a bios and/or a functional operating system of the data processing system. The network interface device 320 may perform interface functions (e.g., code conversion, protocol conversion, and/or buffering) required for communications to and from the network 326 between a number of independent devices (e.g., of varying protocols). The machine readable medium 322 may provide instructions on which any of the methods disclosed herein may be performed. The instructions 324 may provide source code and/or data code to the processor 302 to enable any one/or more operations disclosed herein.

For example, a storage medium having instructions, that when executed by a computing platform executes a method of managing multimedia files of a mobile device by storing metadata associated with the multimedia files in an over-the-air server and allowing one or more mobile subscribers to preview and retrieve desired multimedia files using a CUR.

The storage medium may have instructions to store the metadata associated with the multimedia files in the form of a hierarchical directory structure in the over-the-air server using the CUR, allow a mobile subscriber to view the hierarchical directory structure on a subscriber mobile device using a software client associated with the CUR and residing in the mobile subscriber phone, browse the hierarchical directory structure and select one of the multimedia files using the subscriber mobile device, and preview the selected one of the multimedia files.

Furthermore, a computer system includes a processing unit and a memory coupled to the processor. The memory has code stored therein for managing multimedia files of a mobile device. The code causes the processor to manage multimedia files of a mobile device by storing metadata associated with the multimedia files in an over-the-air server and allows one or more mobile subscribers to preview and retrieve desired multimedia files using a CUR server.

The above technique provides an alternate approach that uses CUR to reduce the number of uploads performed over-the-air by a mobile device to view captured pictures by reducing the amount of data needed to be uploaded to lower the cost of airtime usage by a subscriber. This is achieved by transferring only the metadata associated with the multimedia files and not the entire multimedia file, hence can result in transferring significantly less amount of data over-the-air. During preview of retrieved multimedia file or browsing the hierarchical directory structure stored in the over-the-air server by a mobile subscriber, the above-described technique transfers only the metadata over the air and not the entire multimedia file. The entire multimedia file is transferred only when actually sharing the multimedia file with another desired mobile subscriber and viewing the shared multimedia file. The above technique generally does not require maintaining a separate multimedia storage in the network other than when providing backups.

Also, the method may be in a form of a machine-readable medium embodying a set of instructions that, when executed by a machine, cause the machine to perform any method disclosed herein. It will be appreciated that the various embodiments discussed herein may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising managing multimedia files of a mobile device by storing metadata associated with the multimedia files in an over-the-air server and allowing one or more mobile subscribers to preview and retrieve desired multimedia files using a Common User Repository (CUR).

2. The method of claim 1, wherein the multimedia files comprise files selected from the group consisting of data files, voice files, captured image files, and video files.

3. The method of claim 1, wherein managing the multimedia files of the mobile device comprises:
storing the metadata associated with the multimedia files in the form of a hierarchical directory structure in the over-the-air server;
allowing a mobile subscriber to view the hierarchical directory structure on a subscriber mobile device using a software client associated with the CUR and residing in the mobile subscriber device or a client device connected to the CUR via a mobile or wireless LAN network;
browsing the hierarchical directory structure and selecting one of the multimedia files using the subscriber mobile device; and
previewing the selected one of the multimedia files.

4. A method of managing captured images of a mobile device having an optical image sensor, comprising:
storing metadata associated with each of the captured images in an over-the-air server; and
allowing previewing of the stored metadata and retrieving the captured images via a Common User Repository (CUR).

5. The method of claim 4, wherein storing metadata associated with the captured images comprises:
storing the metadata associated with the captured images in the form of a hierarchical directory structure in the over-the-air server.

6. The method of claim 5, wherein allowing previewing of the stored metadata and retrieving the captured images via the CUR comprises:
allowing a mobile subscriber to view the hierarchical directory structure on a subscriber mobile device using a plug-in module residing in the CUR and associated with the over-the-air server;
browsing the hierarchical directory structure and selecting one of the captured images by the mobile subscriber using the mobile device; and
previewing the selected one of the captured images by the mobile subscriber on the mobile device.

7. The method of claim 6, wherein the hierarchical directory structure includes file names of the captured images.

8. The method of claim 6, wherein storing the metadata associated with the captured images further comprises:
capturing an image with the mobile device;
processing, on the mobile device, the captured image to obtain metadata defining general attributes associated with the captured image using a software client residing in the mobile device;
notifying the over-the-server the captured image based on sensing a change in an image directory in the mobile device by the software client;
receiving the metadata from the mobile device upon receiving the notification by the over-the-air server; and
storing the metadata in the over-the-air server.

9. The method of claim 6, wherein previewing the selected one of the captured images comprises:
previewing the selected one of the captured images on the mobile device in a format selected from the group consisting of compressed format, low resolution format, and thumbnail format.

10. The method of claim 6, further comprising:
allowing accesses to desired group of mobile subscribers and CUR users to view the hierarchical directory structure residing in the over-the-air server to preview a selected one of the captured images listed in the hierarchical directory structure.

11. The method of claim 6, further comprising:
retrieving the previewed one of the captured images by the mobile subscribers and CUR users.

12. An article, comprising:
a storage medium having instructions, that when executed by a computing platform, result in execution of a method of managing multimedia files of a mobile device by storing metadata associated with the multimedia files in an over-the-air server and allowing one or more mobile subscribers to preview and retrieve desired multimedia files using a CUR.

13. The article of claim 12, wherein the multimedia files comprise files selected from the group consisting of data files, voice files, captured image files, and video files.

14. The article of claim 12, wherein managing the multimedia files of the mobile device comprises:
storing the metadata associated with the multimedia files in the form of a hierarchical directory structure in the over-the-air server;
allowing a mobile subscriber to view the hierarchical directory structure on a subscriber mobile device using a software client associated with the CUR and residing in the mobile subscriber device or a client device connected to the CUR via a mobile or wireless LAN network;
browsing the hierarchical directory structure and selecting one of the multimedia files using the subscriber mobile device; and
previewing the selected one of the multimedia files.

15. A mobile multimedia data management system for managing captured images of a mobile device having an optical image sensor, comprising:
an over-the-air server coupled to the mobile device, wherein the over-the-server is configured to store metadata associated with the captured images; and
a CUR server communicatively coupled to the over-the-air server, wherein the over-the-air server stores the metadata associated with the captured images in an hierarchical directory structure upon receiving a notification from the mobile device, wherein the CUR server allows a mobile subscriber to view the hierarchical directory structure on the mobile device using a software client residing in the mobile device, wherein the mobile subscriber browses the hierarchical directory structure and selects one of the captured images using the mobile device, and wherein the mobile subscriber previews the selected one of the captured images.

16. The system of claim 15, wherein the hierarchical directory structure includes file names of the captured images.

17. The system of claim 15, wherein the mobile subscriber captures an image using the mobile device, wherein the mobile device processes the captured image to obtain metadata defining attributes associated with the captured image using the software client, wherein the software client notifies the over-the-server server upon capturing the image based on sensing a change in an image directory, wherein the over-the-air server receives the metadata from the mobile device upon receiving the notification from the software client, wherein the metadata is stored in the over-the air server by the mobile device.

18. The system of claim 17, wherein the mobile subscriber previews the selected one of the captured images on the mobile device in a format selected from the group consisting of compressed format, low resolution format, and thumbnail format.

19. The system of claim 17, wherein the mobile subscriber allows access to other selected one or more mobile subscribers and CUR users to view hierarchical directory structure residing in the over-the-air server and choose a desired one of the captured images from the hierarchical directory structure using the software client via the CUR server.

20. The system of claim 19, wherein the selected one or more mobile subscribers retrieves the desired one of the captured images using the software client via the CUR server.
